(19) United States
(12) Patent Application Publication
(10) Pub. No.: US 2012/0204103 A1
(43) Pub. Date: Aug. 9, 2012

(54) METHODS AND APPARATUS FOR PROCESSING DOCUMENTS

(75) Inventors: Peter D. Stevens, (US); Herb D. Blatt, (US); Michael D. Palmer, (US)

(73) Assignee: Imagitek, Ltd. DBA Prodagio Software, League City, TX (US)

(21) Appl. No.: 13/367,793

(22) Filed: Feb. 7, 2012

Related U.S. Application Data
(60) Provisional application No. 61/440,103, filed on Feb. 7, 2011.

(51) Int. Cl. G06F 17/00

(52) U.S. Cl. 715/273

(57) ABSTRACT

Techniques for adaptively processing a set of documents. The techniques include adaptively processing a plurality of documents associated with one or more transactions by processing at least a first document of the plurality of documents based at least in part on a first rule, wherein the first rule uses a first value for a first parameter associated with the first rule, determining whether to update the first rule based at least in part on a measure of performance evaluated for the first document, and if it is determined based on the measure of performance that the first rule is to be updated, updating the first rule by changing the first value of the first parameter to a second value different from the first value.

### CROSS-REFERENCE TO RELATED APPLICATIONS

The present application claims the benefit under 35 U.S.C. §119(e) of U.S. Provisional Application Ser. No. 61/440,103, filed on Feb. 7, 2011, titled “Adaptive Business Processing Module,” which is hereby incorporated by reference in its entirety.

### FIELD OF INVENTION

The teachings disclosed herein relate to the field of document processing. In particular, the teachings disclosed herein relate to the deployment of methods, in a digital information system environment, to automate the identification and resolution of one or more issues associated with one or more documents.

### BACKGROUND

Document management systems are used to manage electronic documents as well as any data associated with the documents. A document management system may be configured to manage documents by providing functionality to work with the documents, including functionality for accessing, editing, organizing, processing, and storing the documents and any data associated with the documents. A document management system also may be configured to provide functionality for performing one or more actions based on the documents and/or any associated data.

Businesses often use document management systems to manage electronic documents and any associated data used by the business. For example, a business may use one or more document management systems to manage documents related to business areas such as manufacturing, supply chain management, accounting, finance, human resources, project management, and customer relationship management. Specific examples of types of documents include, but are not limited to, inventory records, call center records, health care claims, contracts, e-mails, invoices, payroll records, government aid applications, and purchase orders.

A business may use a document management system to perform one or more actions based on the document(s) being managed by the system. When one or more documents are related to a business transaction, the document management system may be configured to perform one or more actions related to the business transaction based on the document(s) and any associated data. For example, when documents are related to making purchases, the document management system may be configured to manage invoices and to issue a payment for an invoice when the invoice meets certain criteria specified by the business. Similarly, when documents are related to health care claims, the document management system may be configured to manage any documents associated with the health care claim and to process the claim when the document or documents meet certain criteria specified by the business.

Conventional document management systems are not able to automatically perform actions based on the document or documents managed by the system because there may be one or more unresolved issues with the document(s) that the system does not know how to handle automatically. For example, documents may have incorrect or missing information (e.g., an invoice may have an incorrect or missing identifier of the corresponding purchase order, a health care claim may have an incorrect or missing service data, etc.) and the system may not be able to perform the action (e.g., pay invoice, process claim, initiate a quality control process, etc.) until the information is either corrected or added.

Conventional approaches to resolving issues associated with documents involve manual intervention from one or more users trained to resolve such issues. A document having one or more unresolved issues is routed to the user(s) and, in turn, the user(s) analyze the documents and any other relevant information to identify and resolve the issue(s). For example, when an invoice from a vendor is not paid automatically by the document management system, the invoice may be routed to a user and the user may determine why the invoice has not been paid by analyzing the invoice and related information (e.g., invoice history, purchase order data, account charge codes, other documents associated with the same vendor, etc.) to identify issues associated with the document, and subsequently determine how to resolve them.

### SUMMARY

In some embodiments, a computer-implemented method for processing a plurality of documents is provided. The method comprises automatically identifying, using at least one processor, at least one unresolved issue associated with a first document in the plurality of documents, wherein the at least one unresolved issue comprises a first unresolved issue associated with the first document and a second unresolved issue associated with the first document. The method further comprises resolving the first unresolved issue associated with the first document by: presenting information associated with the first unresolved issue to a first user, receiving input from the first user in response to the presented information associated with the first unresolved issue, and resolving the first unresolved issue based at least in part on the input received from the first user. The method further comprises resolving the second unresolved issue associated with the first document by presenting information associated with the second unresolved issue to a second user, receiving input from the second user in response to the presented information associated with the second unresolved issue, and resolving the second unresolved issue based at least in part on the input received from the second user, wherein the first user is a different user from the second user.

In some embodiments, a system for processing a plurality of documents is provided. The system comprises at least one processor configured to identify at least one unresolved issue associated with a first document in the plurality of documents, wherein the at least one unresolved issue comprises a first unresolved issue associated with the first document and a second unresolved issue associated with the first document. The at least one processor is further configured to resolve the first unresolved issue associated with the first document by presenting information associated with the first unresolved issue to a first user, receiving input from the first user in response to the presented information associated with the first unresolved issue, and resolving the first unresolved issue based at least in part on the input received from the first user. The at least one processor is further configured to resolve the second unresolved issue associated with the first document by presenting information associated with the second unresolved issue to a second user, receiving input from the second user in response to the presented information, and resolving the second unresolved issue based at least in part on the input received from the second user, wherein the first user is a different user from the second user.

In some embodiments, another computer-implemented method for processing a plurality of documents is provided. The method comprises automatically identifying, using at least one processor, at least a first unresolved issue associated with a first document in the plurality of documents and at least a second unresolved issue with a second document in the plurality of documents, wherein the first unresolved issue is a same type of issue as the second unresolved issue. The method further comprises resolving the first unresolved issue associated with the first document by presenting information associated with the first unresolved issue to a first user, receiving input from the first user in response to the presented information associated with the first unresolved issue, and resolving the first unresolved issue based at least in part on the input received from the first user. The method further comprises resolving the second unresolved issue associated with the second document by presenting information associated with the second unresolved issue to the first user, receiving input from the first user in response to the presented information associated with the second unresolved issue, and resolving the second unresolved issue based at least in part on the input received from the first user.

In some embodiments, a system for adaptively processing a plurality of documents associated with one or more transactions is provided. The system comprises at least one processor configured to perform acts of processing at least a first document of the plurality of documents based at least in part on a first rule, wherein the first rule uses a first value for a first parameter associated with the first rule, determining whether to update the first rule based at least in part on a measure of performance evaluated for the first document, and if it is determined based on the measure of performance that the first rule is to be updated, updating the first rule by changing the first value of the first parameter to a second value different from the first value.

In some embodiments, a method is provided for adaptively processing a plurality of documents associated with one or more transactions. The method comprises using at least one processor to perform acts of processing at least a first document of the plurality of documents based at least in part on a first rule, wherein the first rule uses a first value for a first parameter associated with the first rule, determining whether to update the first rule based at least in part on a measure of performance evaluated for the first document, and if it is determined based on the measure of performance that the first rule is to be updated, updating the first rule by changing the first value of the first parameter to a second value different from the first value.

In some embodiments, at least one non-transitory computer-readable storage medium is provided. The at least one non-transitory computer-readable storage medium stores processor-executable instructions that, when executed by at least one processor, cause the at least one processor to perform a method for adaptively processing a plurality of documents associated with one or more transactions. The method comprises processing at least a first document of the plurality of documents based at least in part on a first rule, wherein the first rule uses a first value for a first parameter associated with the first rule, determining whether to update the first rule based at least in part on a measure of performance evaluated for the first document, and if it is determined based on the measure of performance that the first rule is to be updated, updating the first rule by changing the first value of the first parameter to a second value different from the first value.

The foregoing is a non-limiting summary of the invention, which is defined by the attached claims.

### BRIEF DESCRIPTION OF DRAWINGS

FIG. 1 illustrates an exemplary computing environment for processing documents, in accordance with some embodiments of the present disclosure.

FIG. 2 shows an illustrative example of resolving issues associated with multiple documents, in accordance with some embodiments of the present disclosure.

FIG. 3A is a block diagram of software components that may be used for processing documents, in accordance with some embodiments of the present disclosure.

FIG. 3B is a block diagram of a data structure configured to store information associated with an issue, in accordance with some embodiments of the present disclosure.

FIG. 4 is a flowchart of an illustrative process for identifying and resolving one or more issues with one or more documents, in accordance with some embodiments of the present disclosure.

FIGS. 5A-5H are illustrative examples of user interfaces that may be presented to a user for resolving one or more issues with one or more documents, in accordance with some embodiments of the present disclosure.

FIG. 6 is a flowchart of an illustrative process for adaptively processing one or more documents, in accordance with some embodiments of the present disclosure.

FIG. 7 is a block diagram generally illustrating an example of a computer system that may be used in implementing aspects of the present disclosure.

### DETAILED DESCRIPTION

The inventors have recognized and appreciated that conventional approaches to identifying and resolving issues associated with electronic documents managed by a document management system can be inefficient and expensive. Manual identification and resolution of issues associated with documents is inefficient in many cases, and can lead to processing delays. Additionally, training users to identify and resolve issues associated with documents is expensive because they not only need to be able to recognize any of numerous types of issues, but also need to know what steps to take in order to resolve them.

The inventors have also recognized and appreciated that many conventional document management systems do not keep track of the issues associated with documents. As such, users need to expend time and effort to identify any issues with the document before they are able to address them. For instance, if an invoice or a claim (e.g., healthcare claim, insurance claim, etc.) has not been automatically paid, a conventional document management system may simply route the invoice/claim to a user without information identifying the issue (e.g., information identifying that the issue is an incorrect purchase order number), and the user needs to identify the issue before he is able to take steps toward resolving the issue.

The inventors have also recognized and appreciated that, in conventional document management systems, issues associated with documents are resolved on a per-document basis. In such a scenario, a document associated with multiple unresolved issues may be sent to a first user to resolve a first issue and, subsequently, to second user to resolve a second issue, and, subsequently, to a third user to resolve a third issue, and so on. This manner of sequential identification and resolution of issues may be time-consuming and inefficient. Alternatively, a single user may need to resolve multiple issues with a single document and, as such, that user may need to perform different tasks and different types of analysis for each issue, which similarly may be inefficient.

The inventors have further recognized and appreciated that resolving issues associated with documents on a per-issue basis may be more efficient and cost-effective than resolving issues on per-document basis. Resolving issues associated with documents on a per-issue basis may avoid the need to process the entire document sequentially—a first user may work to resolve a first issue associated with a document at the same time as a second user may work to resolve a second issue associated with the document—thereby potentially decreasing the amount of time used to resolve the issues associated with the document. In addition, resolving issues with a document on a per-issue basis may allow users to specialize in resolving one or more particular types of issues rather than learning how to resolve any of numerous types of issues that may occur. As a result, each user may be more efficient in resolving the issues that he or she specializes in resolving.

The inventors have further recognized and appreciated that helping users to identify issues with documents may lead to a more efficient and cost-effective issue resolution process. In particular, the inventors have appreciated that automatically identifying and tracking the issues associated with a document may reduce and, in some cases, eliminate the need for a user to spend time identifying the issues with documents.

The inventors have further recognized and appreciated that aiding users to resolve identified issues with documents may also lead to a more efficient and cost-effective issue resolution process. In particular, providing users with a user interface that provides users with suggestions for how to resolve issues may reduce the amount of time that users spend determining what steps to take in order to address the identified issues. As such, the users are able to resolve issues more efficiently and require less training.

The inventors have recognized and appreciated that resolving issues associated with documents on a per-issue, rather than on a per-document, basis and/or aiding the user in identifying and resolving the issues may overcome some of the above-mentioned drawbacks of conventional techniques for identifying and resolving issues associated with documents. However, not every embodiment addresses every one of these drawbacks, and some embodiments may not address any of them. As such, it should be appreciated that the invention is not limited to addressing all or any of the above-discussed drawbacks of these conventional techniques for identifying and resolving issues associated with documents.

Accordingly, in some embodiments, issues with documents may be resolved on a per-issue basis. Information associated with each identified issue of a particular type may be presented to one or more users handling issues of that particular type. As a result, when at least one issue of a first type and at least one issue of a second type are each associated with a particular document (e.g., an invoice is missing a purchase order information, items billed for have already been paid), information associated with the issue(s) of the first type may be presented to one or more users handling issues of the first type and information associated with the issue(s) of the second type may be presented to one or more users handling issues of the second type. Moreover, in some embodiments, when an issue of a particular type is associated with one document and another issue of the same type is associated with another document (e.g., two different government aid applications are each missing information for the corresponding requestors of aid), information associated with each of these issues may be presented to the same user (users) who is (are) handling issues of that particular type.

In some embodiments, information associated with an issue may be automatically identified and tracked by a document management system. As discussed below, such information may be identified in any suitable way including, but not limited to, by using one or more rules. Such information may be presented to a user to aid the user in the process of identifying and resolving issues with documents.

In some embodiments, a document management system may present information associated with an issue to a user by presenting the user with an interface that helps the user to take one or more steps in resolving the issue. The document management system may present the user with an interface that allows the user to provide input that the document management system may use to resolve at least a portion of the issue. As a specific non-limiting example, the document management system may identify that a document is missing a date and may present the user with an interface that enables the user to input a date. The interface may be a graphical user interface or any other suitable type of interface such as a multi-modal interface (e.g., an audio-visual interface), a text-based (e.g., command-line) interface, or any suitable combination thereof.

In some embodiments, presenting an interface to a user may comprise presenting the user with a series of interfaces, each of which may be related to a step in the process of resolving an issue. An interface in the series of interfaces may be used to present at least a portion of the information associated with an issue to the user and/or may enable the user to provide input in response to the presented information.

The inventors have also recognized that an improved document management system may be obtained if the document management system were able to adaptively process the documents which the system is configured to manage. In particular, adapting the manner in which documents are processed may allow for the documents to be processed more efficiently, may decrease per-document processing costs, and/or may enable the document management system to adapt to previously unforeseen circumstances (e.g., new types of issues arising with documents). As such, the workflow associated with a particular issue or a particular document may be dynamic.

Accordingly, in some embodiments, when an operation performed by a document management system is associated with a parameter, the value of that parameter may be changed to a different value based on a measure of performance of the document management system with respect to one or more documents managed by the system. For example, the measure of performance may be indicative of an amount of time that it takes to process a document. As another example, the measure of performance may be indicative of the cost of processing a document.

In some embodiments, one or more operations performed by a document management system may be performed based on one or more rules associated with one or more parameters, and the value(s) of the parameter(s) may be modified based on a measure of performance.

It should be appreciated that the various aspects and concepts of the present invention described herein may be implemented in any of numerous ways, and are not limited to any particular implementation technique. Examples of specific implementations are described below for illustrative purposes only, but the aspects of the invention described herein are not limited to these illustrative implementations.

It should also be appreciated that the various aspects and concepts of the present invention described herein may be applied to any of numerous types of document management systems including, but not limited to, accounts payable systems, health care claim processing systems, government aid application processing systems, and insurance claim processing systems.

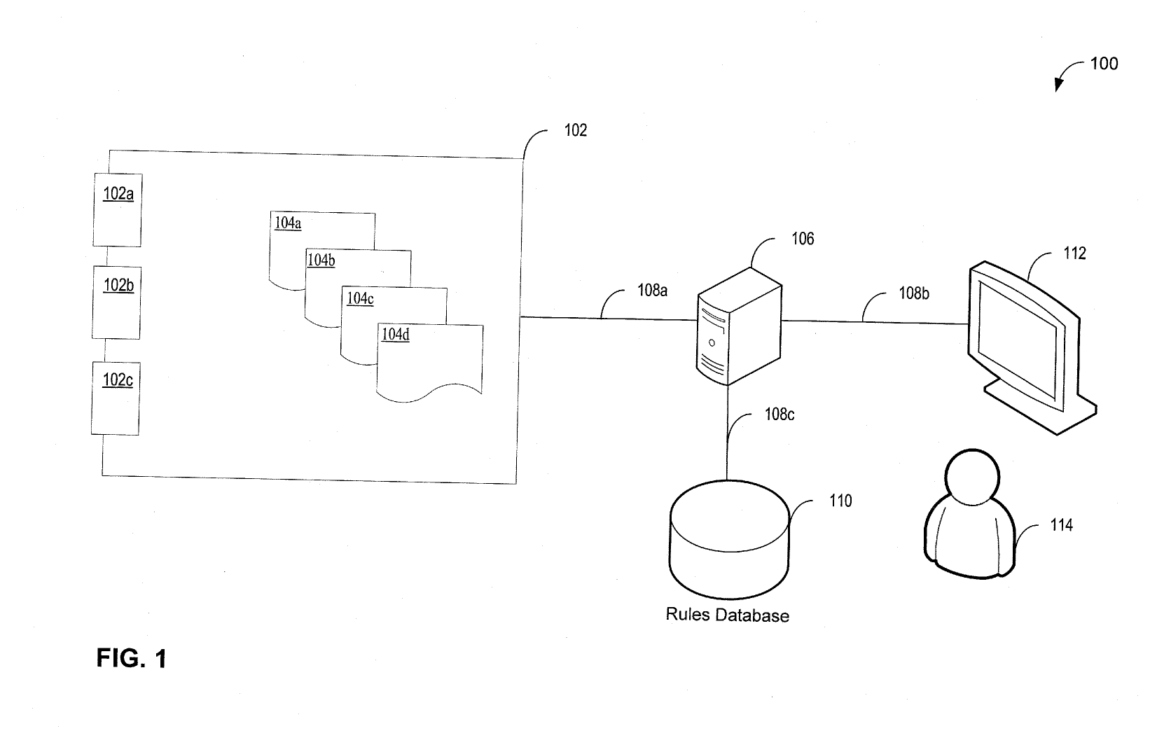

FIG. 1 shows an illustrative environment for processing documents in which some embodiments of the present invention may operate. In particular, FIG. 1 shows a document management system 100. Document management system 100 may be operated by one or more businesses, by a third party or parties on behalf of one or more businesses, and/or by any other entity or entities.

Document management system 100 may be configured to manage any of numerous of types of electronic documents. Electronic documents may comprise any suitable content and, for example, may comprise content related to one or more business transactions. As another example, documents may comprise content related to one or more areas of a business. Though, it should be recognized that document management system 100 is not limited to managing documents whose content is related to one or more business areas and/or transactions and may store documents with any one suitable contents. Documents managed by the document management system may be of any suitable type. For example, a document may be scanned image, a word processing document, a spreadsheet, a presentation, an e-mail, a form, a database file, etc. As such, a document managed by the document management system may comprise any suitable type of data including, but not limited to, text data, image data, pointers to other data of any suitable type, multi-media, and/or any suitable combination thereof.

Additionally, document management system 100 may be configured to manage data associated with one or more documents. Data associated with a document may comprise any suitable type of data and, for example, may comprise data captured from the document and/or any other data related to the document. Data captured from the document may comprise any data captured from the content of the document. For example, in some instances, a document may be stored as an image and data associated with the document may comprise data captured from the image. As a specific, non-limiting example, if the document is a purchase order, data captured from the content of the document may be any data in the purchase order such as any line items in the purchase order, vendor information, price/quantity information, etc.

Data associated with a document may comprise any suitable data that was obtained in any suitable way. For example, data associated with the document may comprise document metadata including, but not limited to, data identifying the author or authors of the document, data identifying the dates on which the document was created and/or modified, data used for identifying the document among other documents managed by document management system, data indicating the type of the document, data summarizing the contents of the document, etc. As another example, data associated with the document may be data associated with one or more other documents related to the document (e.g., data related to an invoice from a supplier may include data from any other documents associated with the supplier, data related to a health care claim may include data from any other documents associated with the service provider, etc.). As another example, data associated with the document may be any suitable data obtained from one or more systems external to the document management system.

Document management system 100 may acquire documents in any of numerous ways. For example, a document may be acquired by being scanned and input via a scanning interface 102a. Scanning interface 102a may be configured to perform optical character recognition (OCR) to capture data from the scanned document; data captured from the document then may be associated with the document, as previously mentioned. As another example, an electronic document may be received via interface 102b from any suitable source communicatively coupled to document management system 100. Electronic documents may be received in any suitable way and may be in any suitable format. For example, a received electronic document may be in an extensible mark-up language (XML) format, electronic data interchange (EDI) format, portable document format (PDF), or in any of numerous other electronic document formats. As yet another example, an electronic document may be created based on data received via interface 102c from an electronic form (e.g. a web-based form). Interface 102c may be configured to create the electronic document from the received data and may be configured to create the electronic document and may be converted to any of the above-mentioned formats or other format for subsequent use.

Regardless of the way that a document is acquired by the document management system, the document may be assigned an identifier and may be stored in a document store 102.

In the illustrated embodiment, document management system 100 comprises document store 102 configured to store multiple documents, such as documents 104a, 104b, 104c, and 104d, which the document management system may be configured to manage. It should be recognized that although, in the illustrated embodiment, document store 102 is shown as storing four documents, the document store may be configured to store any suitable number (e.g., at least 100, at least 1000, at least 10,000, at least 100,000, at least 1,000,000, at least 10,000,000, etc.) of documents.

Document management system 100 comprises server 106, which may be configured to perform any functionality related to document management including, but not limited to, acquiring documents, accessing documents, editing documents, saving documents, and routing documents. It should be appreciated that any of these functions may be performed with respect to a document and/or any data associated with the document.

Server 106 may be also configured to perform one or more actions based on one or more documents (and any associated data) managed by the document management system. Any of numerous types of actions may be performed by server 106 such as, for example, performing any suitable action related to a business transaction. As a specific example, server 106 may be configured to make a payment and/or to place an order for one or more items. Though, it should be recognized that server 106 may be configured to perform any of numerous other types of actions, as the types of actions that may be performed by document management system 100 do not limit aspects of the present invention.

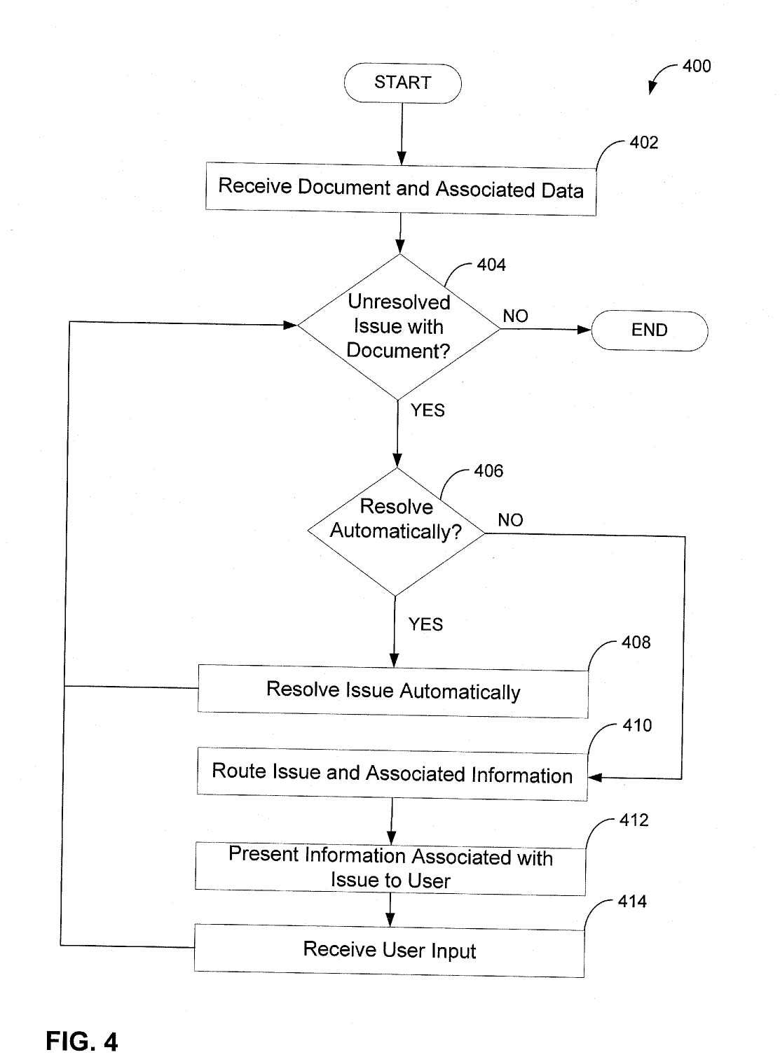

Server 106 may be further configured to automatically identify one or more issues associated with one or more documents. This may be done in any suitable manner and is described in greater detail below with respect to FIG. 4. Server 106 may be configured to identify any of numerous types of issues. For example, server 106 may be configured to identify issues including, but not limited to, data missing from a document (e.g., no purchase order number in an invoice, no age of requester in a government aid application), data incorrectly specified in the document (e.g., incorrect purchase order number in an invoice), data specified inconsistently among documents (e.g., a purchase order and invoice not agreeing on a price and/or quantity of one or more items), inconsistent terms among documents (e.g., contracts specifying conflicting terms), data having values outside a predetermined range, data that may be fraudulent, etc. Though, it should be recognized that the above list of possible document issues is merely illustrative and that many other examples of document issues will be apparent to those skilled in the art. Furthermore, it should be appreciated that server 106 may be configured to recognize new types of issues when new types of issues are identified as issues that would be advantageous for document management system 100 to be configured to identify automatically.

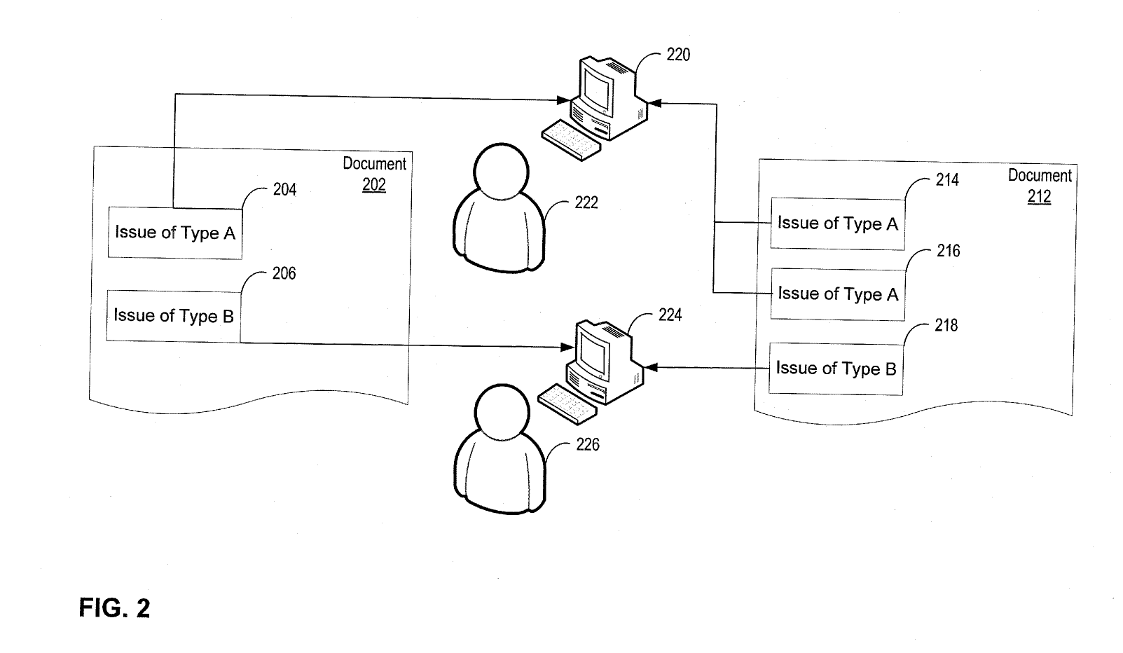

In some embodiments, server 106 may be configured to automatically resolve one or more the issues associated with one or more documents. Additionally or alternatively, server 106 may be also configured to help the user(s) resolve one or more issues associated with the document(s). As such, server 106 may be configured to present information associated with one or more issues to the user(s). For example, server 106 may be configured to present information associated with an issue to a user by presenting the user with an interface that helps the user take one or more steps in resolving the issue. In the illustrated embodiment, server 106 is configured to present information associated with one or more issues to user 114 via a computing device 112. Although, in the illustrated embodiment, server 106 is configured to present information to user 114, presentation to one user is not a limitation of aspects of the present invention as server 106 may be configured to present information associated with one or more issues to multiple users. This is described in greater detail below with respect to FIG. 2.

Server 106 may be configured to perform at least a portion of its functions based on one or more rules. Server 106 may use one or more rules to determine whether to perform one or more actions based on a document and/or any data associated with the document. For example, server 106 may determine whether to perform the action(s) (e.g., make a payment, place an order, route a document, etc.) based on one or more rules specifying criteria to be met before the action(s) may be performed. Server 106 also may use one or more rules to automatically identify one or more issues associated with documents. Server 106 also may use one or more rules to determine whether to present any information associated with one or more issues to a user or users. Though, it should be recognized that these are only examples of functions that server 106 may perform based on rules, and server 106 may perform any other suitable function based on rules. It should also be recognized that server 106 is not limited to performing any of the above-described functions based on rules and, in some embodiments, may be configured to perform any of these functions using any other suitable mechanism in addition to or instead of using rules. In the illustrated embodiment, rules that may be used by server 106 are stored in rules database 110.

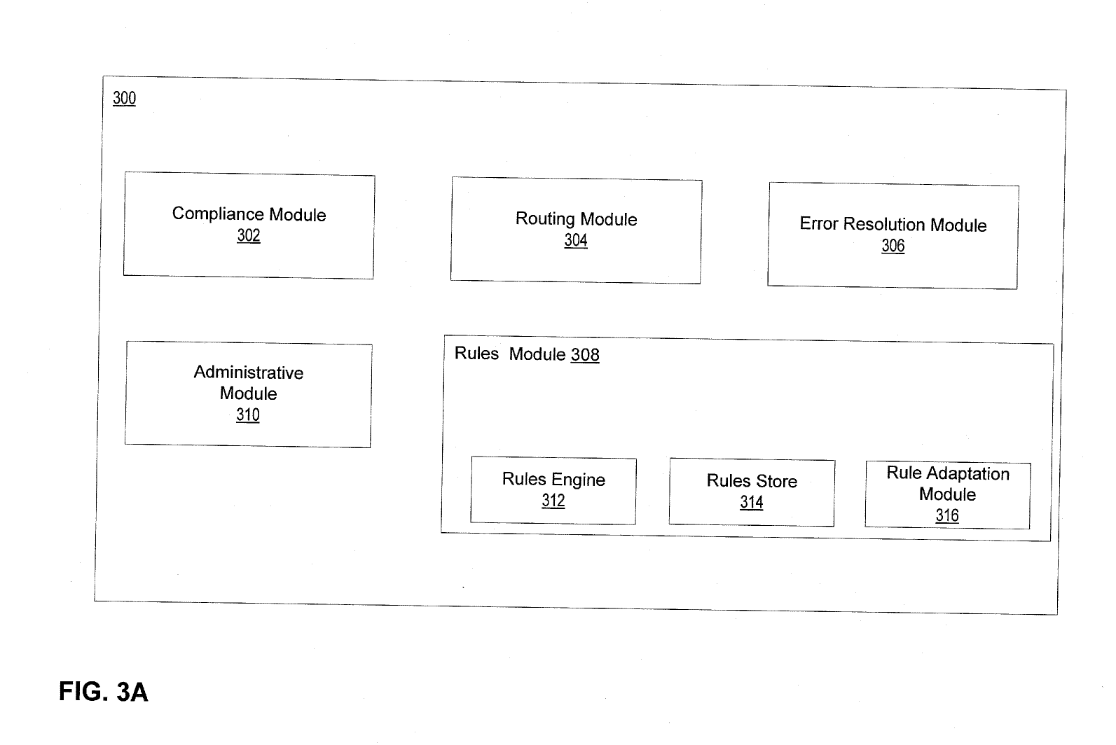

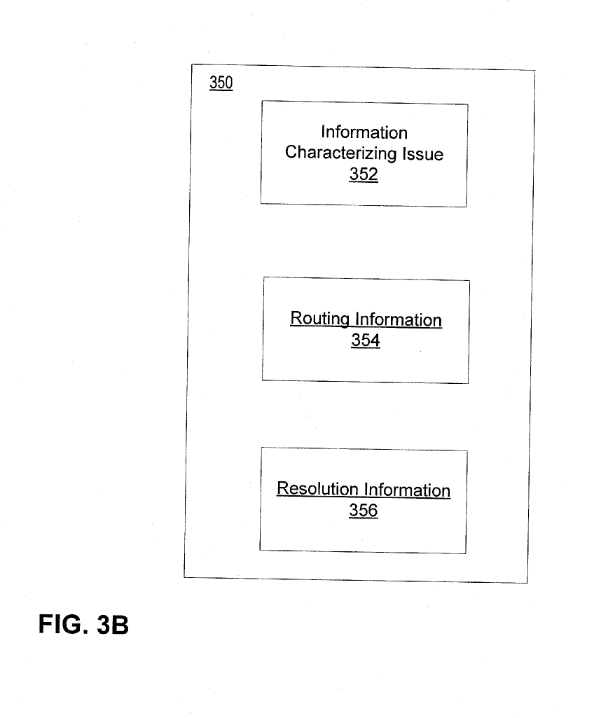

It should also be appreciated that server 106 may comprise a single computing device or multiple computing devices. Server 106 may be configured to execute software components, each component comprising a set of processor-executable instructions, to perform any of the above-described functionality that the server may be configured to perform. Some of these software components are described in further detail with respect to FIGS. 3A and 3B below.

In the illustrated embodiment, server 106 is shown as being communicatively coupled to other portions of document management system 100 using wired connections 108a, 108b, and 108c. However, this wired connection is not a limitation of aspects of the present invention as server 106 may be communicatively coupled to other components of document management system in any suitable manner by using wireless links, wired links, and/or any suitable combination thereof.

As previously mentioned, a document management system (e.g., document management system 100) may be configured to present information associated with one or more issues associated with one or more documents to multiple users. In some instances, information associated with multiple issues associated with a particular document may be presented to multiple users. In other instances, a particular user may be presented with information associated with multiple issues of the same type associated with multiple documents. Both of these scenarios are illustrated FIG. 2.

FIG. 2 shows illustrative documents 202 and 212, each document being associated with multiple issues. In particular, document 202 is shown as being associated with an issue 204 of type A and an issue 206 of type B. Document 212 is shown as being associated with issues 214 and 216 of type A and an issue 218 of type B. In this illustrative example, each of documents 202 and 212 is shown as being associated with two types of issues, but this is not a limitation on aspects of the present invention as any document being managed by the document management system may be associated with any suitable number of types of issues (e.g., at least one type issue, at least two types issues, at least three types of issues, at least five types of issues, at least ten issues, etc.). Furthermore, each document being managed by the document management system may be associated with any suitable number of issues (e.g., no issues, at least one issue, at least two issues, at least three issues, at least five issues, at least ten issues, etc.).

A document management system may be configured to present information associated with one type of issue to a user or users handling that type of issue. In the illustrated example of FIG. 2, for instance, information associated with at least one of issues 204, 214, and 216 (which are all issues of type A) may be presented to user 222 via computing device 220. On the other hand, information associated with at least one of issues 206 and 218 may be presented to user 226 via computing device 224. As such, user 222 may handle issues of type A associated with one or more documents and user 226 may handle issues of type B associated with one or more documents. It should be appreciated, that though in this illustrative example user 222 and user 226 each are shown as handling one type of issue, this is not a limitation of aspects of the present invention as a user may handle multiple types of issues. It should also be appreciated that computing devices 220 and 224 may be any suitable computing devices as the type of computing device used to present information to users and/or receive input from users is not necessarily a limitation of the present invention.

It should also be appreciated that, in the illustrative example of FIG. 2, issues associated with documents may be identified and resolved on a per-issue, rather than a per-document basis. For example, user 222 may perform one or more steps to resolve issue 204 without waiting for user 226 to perform one or more steps to resolve issue 206, and vice versa. Moreover, document 202 need not be presented in its entirety to either of the users. Instead, each user may be presented only with information relating to the one or more issues to be resolved by the user.

FIG. 3A shows a block diagram of some of the software components of an illustrative document management system 300 that may be used to implement techniques described herein related to the functionality of identifying and resolving issues with electronic documents and/or to the functionality of adaptively processing documents. Software components may be stored as processor-executable instructions and configuration parameters and may be stored on any suitable non-transitory computer-readable storage medium or media, including any non-transitory computer-readable storage media described below.

In the illustrated embodiment, document management system 300 comprises various software modules including a compliance module 302, a routing module 304, an error resolution module, a rules module 308, an administrative module 310, and a rule adaptation module 316. Though, it should be recognized that this is only an illustration and that a document management system may comprise any other software modules in addition to or instead of the above-mentioned software modules.

Document management system 300 may be implemented in any suitable way. For example, software components illustrated in FIG. 3A may be configured to execute on a computing device, such as server 106 described with reference to FIG. 1, and/or a plurality of computing devices. It should be appreciated that, in some embodiments, different software modules may be configured to execute on different computing devices. For instance, rules module 308 may be configured to execute on a different computing device from the other illustrated software modules.

Compliance module 302 may be configured to evaluate one or more documents being managed by document management system 300 to identify whether there are any issues with the documents. Compliance module 302 may be configured to evaluate a document at any suitable time. For example, compliance module 302 may be configured to evaluate a document after it is acquired by the document management system or is introduced to the document management system in any other suitable way. As another example, compliance module 302 may be configured to evaluate a document being managed by the document management system any time that the document and/or any data associated with the document is altered. As yet another example, compliance module 302 may be configured to evaluate a document according to a schedule (e.g., periodically after a predetermined time period, randomly, etc.).

Compliance module 302 may be configured to evaluate documents in any suitable way. In some embodiments, compliance module 302 may be configured to evaluate a document based on one or more rules. In such embodiments, compliance module 302 may be configured to use a rules engine (e.g., rules engine 312 described in more detail below) to evaluate the rule(s) by using data associated with the document. Additionally or alternatively, compliance module 302 may be configured to use a rules engine to evaluate the rule(s) by using any other suitable data (e.g., data associated with one or more other documents, legacy system data, various configuration parameters, etc.). Though, it should be recognized that compliance module 302 is not limited to using rules to identify one or more issues with a document and may be configured to evaluate the document in any other suitable way using any other suitable techniques.

Compliance module 302 may use any of numerous rules to identify one or more issues with a document. The rules may embody one or more conditions that may be indicative of the presence of one or more issues with the document. As such, one or more rules may be used to obtain an indication that there may be one or more issues with the document. For example, compliance module 302 may use one or more rules to obtain an indication that there may be missing data in the document and/or data associated with the document (e.g., evaluating the rule(s) may produce an indication that there is an issue with an invoice if the invoice is missing a corresponding purchase order number). As another example, compliance module 302 may use one or more rules to obtain an indication that there may be incorrectly-specified data in the document and/or data associated with the document (e.g., evaluating the rule(s) may produce an indication that there is an issue with an invoice if the purchase order number specified in the invoice does not correspond to an actual purchase order, evaluating the rule(s) may produce an indication that there is an issue with an application for government aid submitted by a citizen if the citizen's age or location is outside a predetermined range, etc.). As yet another example, compliance module 302 may use one or more rules to obtain an indication that there may be data in a document inconsistent with terms in the document or another document (e.g., evaluating the rule(s) may produce an indication that there is an issue with an invoice if the invoice includes terms inconsistent with terms in a corresponding purchase order or a previously-executed contract between the purchaser and supplier). Accordingly, compliance module 302 may use one or more rules to identify an issue with a document by using one or more other documents.

In some embodiments, compliance module 302 may determine which rule or rules to use in order to identify issues with a document. This determination may be made in any suitable way. For example, this determination may be made based on any of numerous factors including, but not limited to, the type of document being evaluated for compliance, types of rules available, and values of data associated with the document.

When a document is associated with one or more issues, document management system 300 may present information associated with the issue(s) to one or more users so that the users may provide input that may be used to resolve the issue(s). Accordingly, document management system 300 may use routing module 304 to route information associated with an issue of a particular type to a user or users that may handle issues of that particular type. Additionally or alternatively, document management system 300 may use routing module 304 to route information associated with an issue to an automated module that may be configured to handle the issue. For example, if an issue associated with a document relates to data missing from the document, routing module 304 may determine that information associated with the issue (e.g., information identifying what data is missing from which document) may be routed to a user that may provide input specifying the missing data. Additionally or alternatively, routing module 304 may determine that information should be routed to a user an automated module which is configured to supply this missing data. Any suitable information associated with an issue may be routed including, for example, such information as described below with reference to FIG. 3B. Though, it should be recognized that in some embodiments, an issue may be resolved using any of the techniques described herein without the issue, or any information associated with it, being routed.

Routing module 304 may be configured to determine one or more destinations to which information associated with an issue may be routed. This determination may be made in any suitable way and, for example, may be made by using a rules engine (e.g., rules engine 312) to evaluate one or more rules to obtain an indication of the destination or destinations to which to route information associated with the issue. As such, information associated with an issue may be routed based on evaluating one or more rules using data associated with the document.

Error resolution module 306 may be configured to automatically resolve one or more issues with a document. This may be done in any suitable way. For example, error resolution module 306 may be configured to automatically resolve the issue(s) by using a rules engine to evaluate one or more rules, which may lead to the calling of one or more software modules to automatically resolve the issue(s). Though, it should be recognized that error resolution module 306 may be configured to automatically resolve one or more issues with the document in any other suitable way.

Additionally or alternatively, error resolution module 306 may be configured to interact with one or more users to aid them in taking one or more steps toward resolving the issue(s). This interaction may be performed in any suitable way. In some embodiments, error resolution module 306 may interact with a user by presenting information associated with an issue to the user via an interface to help the user to take one or more steps in resolving the issue. Error resolution module 306 may be configured to present, via the interface, any of numerous types of information associated with the issue to the user including, but not limited to, information characterizing the issue and information that the user may use when resolving the issue.

Additionally, error resolution module 306 may be configured to receive, via the interface, one or more inputs from the user. Error resolution module 306 may be configured to use inputs provided by the user to resolve at least a portion of the issue. The user's inputs may be used in any suitable manner. For example, input provided by the user may be used to insert data into the document and/or data associated with the document (e.g., insert missing data). As another example, input provided by the user may be used to edit data in the document and/or data associated with the document (e.g., change incorrect and/or inconsistent data). As another example, input provided by provided by the user may indicate one or more actions for the system to take automatically (e.g., route information associated with the issue to another user) and/or for another user to take (e.g., the other user may provide additional input) in order to resolve the issue. As such, input provided by the user may bring about the performance of the action(s) specified in the user's input.

Error resolution module 306 may be configured to present any suitable type of interface to a user. As previously mentioned, the interface may be a graphical user interface, a web-based interface, a text-based interface, a multi-modal interface, or any suitable combination thereof. In cases where the interface is a graphical user interface, it may be designed/styled in any suitable way and, for example, may be designed as a software wizard comprising a series of graphical user interfaces. More generally, error resolution module 306 may be configured to present an interface to the user by presenting a user with a series of interfaces, each of which may be configured to provide a user with at least a portion of the information associated with an issue and/or gather input from the user which may be used for resolving at least a portion of the issue.

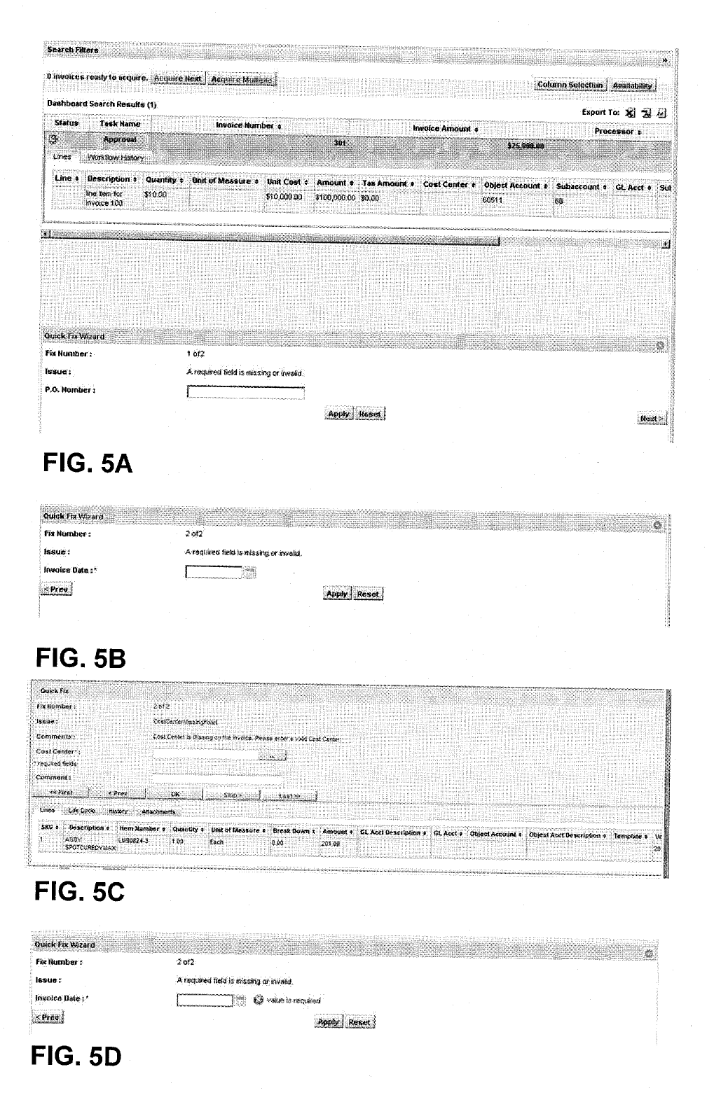

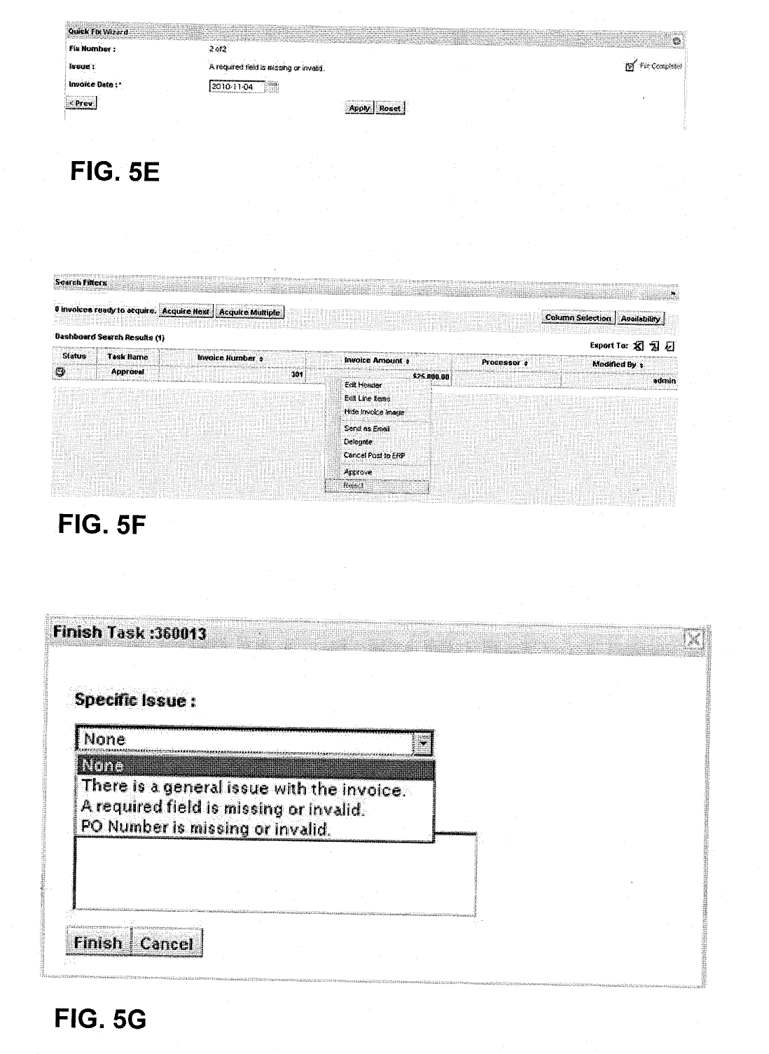

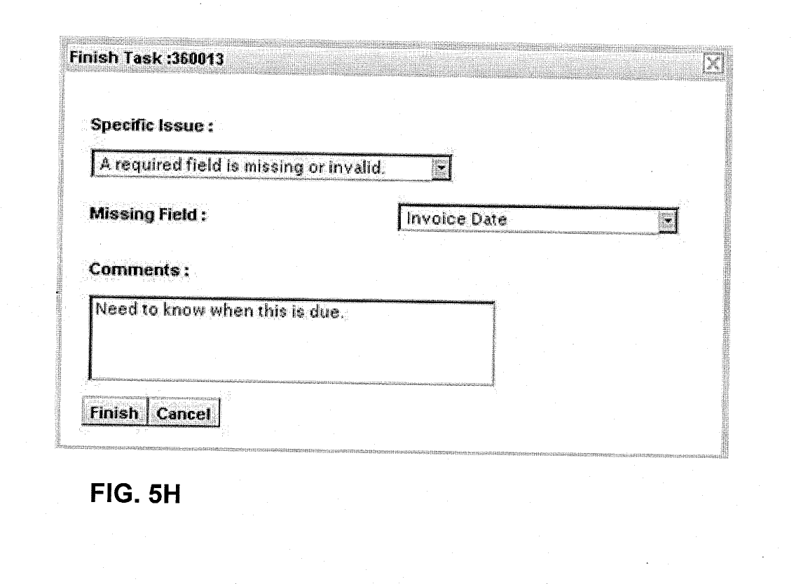

Accordingly, the error resolution module may be configured to present the user with a series of interfaces to guide the user through the process of resolving the issue. For example, if one issue associated with a document is that the document is missing certain data (e.g., a contract is missing an address of one of the contracting parties, a health care claim is missing information about the party who submitting the claim, etc.), error correction module 306 may be configured to present an interface to a user informing the user of the presence and nature of the issue and another interface to allow the user to provide input to resolve the issue (e.g., the user may input the missing address). Other examples are described in greater detail below with respect to FIGS. 5A-5H.

Any of the above-mentioned software modules of a document management system or any other software module of the system may use at least one rules engine to evaluate one or more rules. For example, as described above, compliance module 302 may evaluate a document for the presence of any issues by using a rules engine to evaluate one or more rules to obtain an indication that there may be an issue with the document.

Accordingly, document management system 300 comprises rules module 308, which comprises rules engine 312, a rules store 314, and rule adaptation module 316. Rules engine 312 may be any suitable rules engine and may be provided by any suitable party (e.g., third-party software vendor/distributor, document management system vendor/distributor, document management system user, document management system administrator, etc.). Rules engine 312 may be configured to evaluate rules in any suitable way, as the way that rules engine 312 evaluates rules is not a limitation of aspects of the present invention.

Rules engine 312 may be configured to evaluate one or more rules stored in rules store 314, which may store any suitable number of rules of any suitable type. Rules stored in rule store 314 may be default rules provided with rules engine 312 and/or with document management system 300. Additionally, rules stored in rules store 314 may be configured and/or specified by one or more users of the document management system and/or one or more administrators of the document management system. As described in further detail below, any rules stored in rules store 314 may be modified manually (e.g., by a user and/or administrator of the document management system) or automatically by the document management system. It should be recognized that rules engine 312 is not limited to evaluating rules stored in rules store 314 and may be configured to evaluate any other suitable rule or rules.

A rule may be associated with one or more parameters. Storing a rule (e.g., in rules store 314) may comprise storing one or more values of the one or more parameters associated with the rule.

A rules engine, such as rules engine 312, may be configured to evaluate a rule to produce a result of evaluating the rule at least in part by setting values of the rule parameters. In some embodiments, rules engine 312 may be configured to evaluate a rule by using data associated with a document or documents to set a value or values of any parameters associated with the rule. For example, consider a rule for evaluating whether an invoice should be paid without being examined for the presence of any issues. Such a rule may be associated with a first parameter whose value indicates the overall amount that the invoice is for and a second parameter whose value indicates a threshold amount such that if the invoice is for an amount below the threshold amount, the invoice may be paid without being examined for the presence of any issues. Rules engine 312 may evaluate such a rule by using data associated with the invoice to set the value of the first parameter. Additionally, rules engine 312 may evaluate this rule by using any other suitable data to identify the threshold amount.

In some embodiments, document management system 300 may use a rules engine to evaluate the one or more rules using data associated with a document to determine how to process the document. For example, document management system 300 may determine, as a result of evaluating one or more rules, whether to identify one or more issues associated with the document. As another example, document management system 300 may determine, as a result of evaluating one or more rules, whether to route information with any identified issue to a user. As yet another example, document management system 300 may determine, as a result of evaluating one or more rules, whether to automatically resolve and/or interact with a user to help the user take one or more steps toward resolving the issue.

Rules module 308 further comprises a rule adaptation module 316. As previously mentioned, a rule may be associated with one or more parameters such that the value of the parameter(s) may be used by a rules engine when evaluating the rule. Rule adaptation module 316 may be configured to modify values of any parameters associated with one or more rules. Rule adaptation, by way of modifying values of rule parameters, may be performed in any of numerous ways, and may be performed based on a measure of performance of the document management system with respect to one or more documents managed by the system. For example, rule adaptation module 316 may be configured to adapt a set of rules based on a measure of performance of the document system with respect to managing those documents which were processed in any way by using the set of rules. As a specific example, rule adaptation module 316 may be configured to adapt a rule for determining whether to a process a document of a particular type based on a measure of performance of the document management system with respect to managing documents of that particular type. It should be appreciated that a document management system configured to update rules may adaptively process the documents it manages.

Rule adaptation module 316 may be configured to use any suitable measure of performance to adapt rules. In some embodiments, the measure of performance for a document may be indicative of a cost of processing the document. For example, the cost of processing a document automatically may be higher than the cost of processing the same document with manual intervention (e.g., having a user resolve an issue with the document). In some embodiments, the measure of performance for a document may be indicative of an amount of time spent processing the document. For example, in some embodiments, automatically processing a document may be faster than processing the same document with manual intervention. Another measure of performance may be based on any suitable combination of the above two measures of performance. Such measures of performance may be calculated in any suitable way using any suitable data collected by the document management system. Though, it should be recognized that these are only examples of measures of performance and that any of other numerous measures of performance may be used.

Regardless of which measure of performance is used, rule adaptation module 316 may be configured to evaluate the measure of performance with respect to any suitable document or documents managed by the document management system. The measure of performance may be evaluated with respect to documents satisfying a particular condition or criterion. For example, the measure of performance may be evaluated with respect to documents processed in a particular time period. As another example, the measure of performance may be evaluated with respect to documents processed by using one or more particular rules.

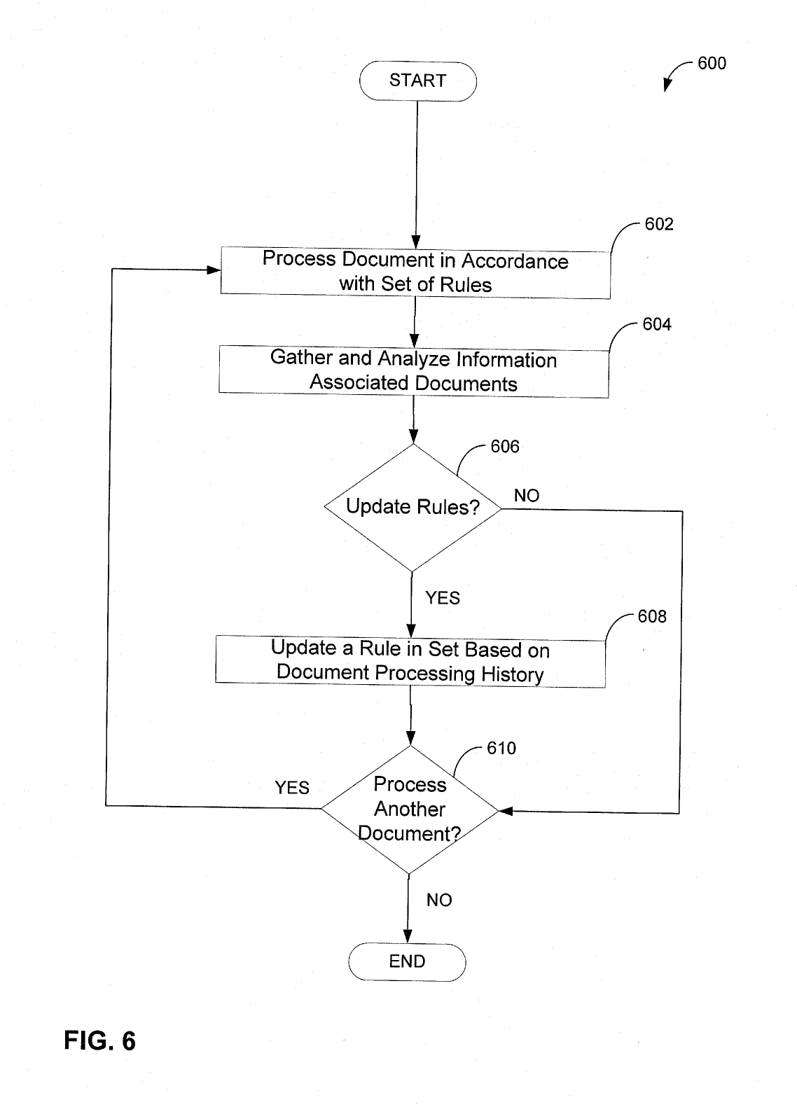

Rule adaptation module 316 may be configured to update one or more rules at any suitable time. For example, rule adaptation module 316 may be configured to update rules periodically at a predetermined time interval. Any suitable time interval may be used such as, but not limited to, an hourly, daily, weekly, bi-weekly, or monthly time interval. Additionally or alternatively, rule adaptation module 316 may be configured to update rules at random times. The ways in which rule adaptation module may update one or more rules are discussed in greater detail below with reference to FIG. 6.

Document management system 300 further comprises administrative module 310 which allows the document management system to be configured. Administrative module 310 may allow one or more administrators (and/or any other suitable party that may adjust any of the settings of the document management system) to configure any of the above-described software modules and any other configurable parameters/settings of the document management system. For example, administrative module 310 may allow one or more administrators to configure rules in rules store 314 by modifying existing rules, deleting existing rules, and/or introducing new rules. As a specific example, administrative module may allow the administrator(s) to modify, delete, and/or introduce one or more rules used by compliance module 302, routing module 304, and/or error resolution module 306. As another example, administrative module 310 may allow the administrator(s) to set up one or more interfaces that error resolution module 306 presents to users.

It should be recognized that document processing system 300 may comprise other software modules in addition to or instead of the above-described software modules. For instance, document processing system may comprise an analytics module configured to analyze the manner in which document management system 300 manages documents. For example, the analytics module may analyze the history of operations performed by the document management system related to identifying and resolving issues with documents in order to determine things such as, but not limited to, the types of issues that occur more frequently than others, the issues that have been successfully resolved, the manner in which issues have been resolved, the users that were efficient in resolving issues and those that users were not, and the cost of processing one or more documents.

Information gathered by the analytics module may be used in any suitable way. For example, the gathered information may be used to generate one or more reports to present to an administrator of the document management system. As another example, the gathered information may be used to adaptively process documents as described in greater detail below with respect to FIG. 6.

As previously mentioned, in some embodiments, a document management system may be configured to provide for resolution of issues associated with one or more documents on a per-issue basis. To this end, a document management system may be configured to organize information associated with an issue such that the organized information may be used by various components of the document management system (e.g., the components described above) independently from the document with which that issue is associated.

In some embodiments, information associated with an issue may be organized by using a data structure configured to store at least a portion of the information associated with the issue and/or to store references/pointers indicative of a location where at least a portion of this information may be stored. The data structure may comprise one or more fields for storing information or references/pointers to information. In some embodiments, compliance module 302 may instantiate such a data structure for every issue identified by compliance module 302. Other software modules, such as routing module 304 and error resolution module 306, may access data in the data structure and/or write data into the data structure as part of performing their functionality.

The document management system may be configured to perform any suitable operations associated with the identification and/or resolution of an issue based at least in part on information contained in such a data structure associated with the issue. For example, the document management system may be configured to present information characterizing the issue to a user at least in part by accessing information in the data structure associated with the issue. As another example, the document management system may store information associated with routing an issue in the data structure associated with the issue. As yet another example, the document management system may store information associated with resolving an issue (e.g., input provided by a user) in the data structure associated with the issue. Though, it should be recognized that these examples are merely illustrative and that a data structure associated with an issue may be used to organize any other suitable information in addition to or instead of the types of information described above.

In some embodiments, a document management system may be configured to organize information associated with multiple issues associated with a single document by using multiple instances of the above-described data structure. These instances may allow for discrete packaging of information associated with each issue and allow the document processing system to perform processing tasks related to each issue independently from any processing tasks related to other issues, and independently from any other processing related to the document with which the issues are associated.

Information stored in and/or referenced by a data structure associated with an issue may be stored and may be subsequently accessed. This may be done in any suitable way, as aspects of the present invention are not necessarily limited in this respect. Though, it should be recognized that as a result information associated with issues may be tracked and/or audited. For instance, a document management system may keep track of which issues have been identified, which issues have been resolved, which issues have not been unresolved, and/or any other suitable information.

FIG. 3B shows an illustrative data structure 350 for organizing information associated with an issue. As previously mentioned, data structure 350 may store at least a portion of such information or a pointer/reference to where at least a portion of such information may be stored. Illustrative data structure 350 includes at least one field 352 for organizing information characterizing the issue, and may include a plurality of such fields. Information characterizing an issue may include, but is not limited to, information indicating the type of the issue, an identifier of the issue, information that may be presented to a user or users to aid the users in resolving at least a part of the issue, and information that a document management system may use to resolve the issue automatically and/or with one or more inputs from the user.

Illustrative data structure 350 also includes at least one field 354 for organizing routing information related to a workflow or workflows for resolving the issue. Routing information may comprise information indicating who or what may resolve the issue. For example, routing information may indicate a user or users that may resolve the issue such that information associated with the issue is presented to this user or users. As another example, routing information may indicate that the issue should be resolved automatically by the document management system without manual intervention.

Illustrative data structure 350 also includes at least one field 356 for organizing resolution information associated with an issue. Resolution information may comprise any information related to how the issue has been, is being, or may be resolved. For example, resolution information may comprise one or more inputs provide by one or more users handling the issue. As another example, resolution information may comprise a record of one or more steps taken by the system and/or user(s) in resolving the issues.

The software components described in FIGS. 3A-3B may be used in any of numerous methods for resolving one or more issues associated with one or more documents. One such method is illustrated in for FIG. 4, which is a flowchart of an illustrative process 400 for identifying and resolving one or more issues associated with one or more documents. Process 400 may be executed by a document management system (e.g., document management system 100) and may be executed by using any suitable hardware (e.g., server 106) and/or software components (e.g., components 302-316) of the document management system.

Process 400 begins in an act 402, in which a document along with any associated data may be received. The received document may be any suitable document being managed by a document management system. The document and associated data may have been acquired by the document management system in any of numerous ways including any of the previously-described manners (e.g., scanning and OCR, receiving electronic document from another source communicatively coupled to the document management system, creating a document from data obtained from an electronic form). The document may be in any suitable format and may be any suitable type of document including any of the previously-described types of documents (e.g., documents related to a business transaction or a business area).

Next, process 400 proceeds to a decision block 404, where it is determined whether there are one or more unresolved issues associated with the document. This may be done in any suitable way. The document may be evaluated to identify whether there are any unresolved issues with the document by using any of the techniques previously described with respect to compliance module 302. Additionally or alternatively, the document may have already been evaluated and one or more issues may have been identified and associated with the document. In this scenario, determining whether there are one or more unresolved issues with the document may include checking whether all of the previously-identified issues have been resolved.

If it is determined in decision block 404 that there are no unresolved issues associated with the document, process 400 completes. On the other hand, if it is determined in decision block 404 that there is at least one unresolved issue associated with the document, process 400 proceeds, via the YES branch, to decision a block 406, where it is determined whether one of the unresolved issues may be resolved automatically.

The determination of whether an unresolved issue may be automatically resolved may be made in any suitable way. For example, the determination may be made based on the type of the unresolved issue. In particular, the determination may be made based on whether the document processing system may be configured to automatically resolve this type of issue. As another example, the determination may be made based on the importance of the document. For example, if the document is deemed sufficiently important (e.g., an invoice (or health care claim, insurance claim, application for government aid, etc.) is for an amount exceeding a predetermined threshold), it may be determined that any unresolved issue associated with the document may should not be automatically resolved. This approach may be advantageous in that important documents are reviewed by one or more trained users before any actions are taken based on the documents and associated data. In some instances, the determination may be made by using a rules engine (e.g., rules engine 312) to evaluate one or more rules to obtain an indication whether the unresolved issue may be automatically resolved.

If it is determined in decision block 406 that the unresolved issue should be automatically resolved, process 400 proceeds via the YES branch to an act 408, where the unresolved issue is automatically resolved. The unresolved issue may be automatically resolved in any suitable way including any of the ways previously described with respect to error resolution module 306. After the unresolved issue is automatically resolved in act 408, process 400 loops back to decision block 404 where it is determined whether there is any other unresolved issue associated with the document.

Conversely, if it is determined in decision block 406 that the unresolved issue should not be automatically resolved, process 400 proceeds via the NO branch to an act 410, where information associated with the unresolved issue is routed to a user such that the user may help to resolve the issue. This may be done in any suitable way including any of the ways previously discussed with respect to routing module 304. For example, the information associated with the unresolved issue may be routed to any suitable user that may help to resolve the issue. In some embodiments, the unresolved issue may be of a particular type and information associated with the issue may be routed to a user handling issues of that particular type. Accordingly, the act of routing information associated with an unresolved issue to a user may include determining the type of the unresolved issue in order to identify the user or users to whom information associated with the unresolved issue should be routed. This may be done in any suitable way and, for example, may be done by using a rules engine to evaluate one or more rules for routing information associated with unresolved issues.

Next, process 400 proceeds to an act 412, in which information associated with the unresolved issue may be presented to a user. This may be done in any suitable way including any of the ways previously described with respect to error resolution module 306 in FIG. 3A.

Process 400 also includes an act 414, in which input from the user is received. The input may be provided by the user in response to any information presented to the user during act 412. Any of numerous types of input may be received from the user. For example, the input received may include text entered by the user, a form filled out by a user, a checkbox checked by the user, a menu item selected by a user, speech spoken by the user, handwritten text entered by the user, etc. Additional examples of user-provided input are described below with reference to FIGS. 5A-5H.

The input received from the user may be used to partially or fully resolve the unresolved issue. This may be done any of the ways previously described with respect to error resolution module 306. After act 414, process 400 may loop back to decision block 404, where it is determined whether there is any other unresolved issue associated with the document.

It should be appreciated that identifying and resolving one or more issues with a document may be an iterative process so that after one or more issues with the document should be resolved, the document may be checked to see whether one or more other issues may be resolved. Even though in the illustrated embodiment, one or more acts of the process may include taking steps toward the resolution of an unresolved issue, it should also be appreciated that the issue may not be fully resolved as a result of taking these steps. For example, a user may provide only a portion of data missing from a document, or a software module configured to automatically resolve an issue may not resolve the issue and/or introduce another issue (e.g., resolving one issue number may enable the system to identify other rules and/or types of issues to identify). As such, the iterative nature of process 400 may be advantageous in that the process is not complete until all unresolved issues have been addressed. Though, in some embodiments, process 400 may be completed even if some issues are not resolved, for example to expedite document processing.

It should be recognized that process 400 is merely illustrative and that many variations of process 400 are possible. For example, although in the illustrated embodiment process 400 is shown as performing acts 404-414 sequentially for each issue identified, process 400 may be adapted to process multiple issues simultaneously. In some embodiments, any one or more of acts 404-414 are being performed for one issue while any of acts 404-414 may be performed for another issue. As a specific example, act 412 of presenting information associated with an unresolved issue to a user may be performed while any of acts 404-414 may be performed for another issue (e.g., receiving input regarding the resolution of the other issue from the other user in act 314). As another example, although process 400 is described with respect to identifying and resolving issues associated with a single document, in some embodiments process 400 may be adapted to simultaneously resolve issues associated with multiple documents. As yet another example, although in the illustrated embodiment, an issue may either be resolved automatically or manually, in some embodiments process 400 may be modified to not resolve certain types of issues.

FIGS. 5A-5H shows illustrative examples of user interfaces that may be presented to a user for resolving one or more issues with one or more documents managed by a document management system. The illustrated examples may be presented to the user in a sequence. The illustrated interfaces are configured to present information associated with one or more issues associated with the document(s). It should be recognized that the examples are merely illustrative and that any other suitable user interfaces may be used to present information about one or more issues to a user.

FIG. 5A illustrates a user interface configured to present information associated with an issue with an invoice. In this example, the amount of the invoice is $100,000.00 and, as such, the invoice may be for an amount that exceeds a predetermined threshold amount above which an invoice is processed to identify and/or resolve any issues associated with the invoice. In the illustrated embodiment, the user interface is a graphical user interface configured to present information to the user informing the user that the purchase order number is missing from the invoice and to provide a text box in which the user may input the missing purchase order number. Though, it should be recognized that the user interface may be configured to present information to the user associated with any issue of any type with a document, as the invention is not limited in this respect.

FIG. 5B illustrates a user interface configured to present information associated with another issue with the invoice. In particular, the illustrated user interface is a graphical user interface configured to present information to the user, informing the user that the invoice date is missing from the invoice and to provide a text box in which the user may input the missing invoice date. Both of the issues illustrated in FIGS. 5A and 5B may have been identified automatically in any suitable way and, for example, may have been identified in accordance with any of the previously-described techniques for identifying one or more issues with a document.

It should be recognized that any suitable type of graphical user interface may be used to present information associated with one or more issues to a user. The graphical user interface may be designed in any suitable way as the specific design of the graphical user interface is not a limitation of the present invention. For example, FIG. 5C shows another example of a user interface configured to present information associated with an issue to a user.

In some embodiments, as shown in FIGS. 5A-5C, a user may be able to browse the issues by using buttons such as “Prey” or “Skip” so that the user may provide input to help resolve issues in an order different from the order in which information associated with these issues is presented to the user. However, in some embodiments, the user interface may be configured to require that a user provide input to help resolve an issue. For example, the user interface is shown in FIG. 5D is shown as requiring the user to provide an invoice date before the user may navigate to another issue or complete the issue resolution process. After a user inputs an invoice date, the inputted date may be used to resolve the issue; the user is presented with a “fix complete” message as illustrated in FIG. 5E.

A user may take any of numerous actions associated with a document. As shown above, the user may provide input to help resolve one or more issues associated with the document. Additionally, as shown in FIG. 5F, the user may provide input associated with one or more actions that the document management system may take with respect to the document. For example, the user may approve (or reject) taking of any actions (e.g., making an automatic payment, placing an order, etc.) associated with the document (e.g., invoice, health care claim, government aid request, etc.). In FIG. 5F, for instance, the user is shown as rejecting payment of an invoice for $25,000.

A user may provide any of numerous other types of input to help resolve an issue. For example, as shown in FIGS. 5G and 5H, the user may provide comments associated with an issue. Though, it should be appreciated that a user interface or interfaces may be configured to gather any other information from the user.

FIG. 6 shows an illustrative process 600 for adaptive processing of one or more documents managed by a document management system. Process 600 may be executed by a document management system (e.g., system 100, system 300, etc.) and may be executed by using any suitable hardware (e.g., server 106) and/or software components (e.g., components 302-316) of the document management system. In particular, some acts of process 600 may be performed by rule adaptation module 316. Process 600 may enable adaptive processing of documents by way of adapting rules used by the document management system to perform one or more operations on the managed documents.

Process 600 begins in act 602, in which one or more documents may be processed in accordance with a set of one or more rules. Any suitable documents managed by the document management system may be processed in accordance with any suitable rules. For example, any document may be checked for the presence of issues in accordance with rules used by compliance module 302, as previously described. More generally, any document may be processed by any software module and/or component of the document management system in accordance with rules utilized by that software module and/or component. As another example, a document management system may evaluate one or more rules to determine whether a document should be checked for the presence of issues and/or whether to resolve one or more unresolved issues with the document. For instance, a document management system may evaluate one or more rules to determine whether to check for the presence of issues in an invoice or a contract and/or whether to resolve one or more unresolved issues with the invoice or the contract.

The set of rules used in act 602 may include any rules that may be evaluated by a document processing system. Each rule may be associated with one or more parameters. For example, a rule for evaluating whether a document should be processed in a particular way (e.g., whether the document should be checked for the presence of issues, whether information associated with issues in the document should be routed, whether any unresolved issues with the document should be resolved, etc.) may be associated with a parameter such that the determination of whether to process the document in this particular way may be made based on a comparison of data associated with the document and the value of the parameter. For example, when the amount an invoice is for is below a predetermined threshold (e.g., $100 or less, $500 or less, $1000 or less, etc.), it may be determined that the invoice should not be checked for the presence of issues. As another example, if the amount that an invoice is for varies from a predetermined amount (e.g., an amount on the purchase order, an expected amount, etc.) by less than a pre-specified percentage of the predetermined amount, it may be determined that the invoice should not be checked for the presence of issues. Such a rule may be advantageous in a scenario in which the cost of identifying and/or resolving issues, potentially with manual intervention by one or more users, may cost more than the amount of the invoice.

Next, process 600 proceeds to act 604, where information associated with documents managed by the document management system may be gathered and analyzed. For example, information associated with documents may include information related to processing of the documents such as, but not limited to, information related to cost of processing the documents, information related to the amount of time used to process the documents, information about specific operations performed by the document management system on the documents and/or associated data, information about what issue or issues with the documents were identified, information about how issues associated with documents were resolved, and any information logged or otherwise stored by the document management system. As a specific example, when a document management system manages invoices, any suitable information associated with the processing of the invoices may be gathered in act 602. For instance, information about how many invoices associated with one or more unresolved issues (e.g., amount on an invoice is an incorrect amount) were paid may be gathered.

As another example, information associated with documents may include data contained in the documents and/or data associated with the documents. Though, it should be recognized that these examples are merely illustrative and that any suitable data associated with the documents may be gathered and analyzed in act 604.

The gathered information may be analyzed in any suitable way. In some embodiments, analyzing the gathered information may comprise evaluating one or more measures of performance. Any suitable measure of performance may be used including, but not limited to, the measures of performance described with reference to rule adaptation module 316. The measure of performance may be indicative of a cost associated with processing one or more documents of a particular type, or an amount of time associated with processing one or more documents of a particular type.

In some embodiments, analyzing gathered information to evaluate a measure of performance may comprise identifying one or more patterns or trends in the gathered information. For example, evaluating a measure of performance may comprise identifying an average cost of processing a particular type or types of documents (e.g., a contract, an invoice, etc.), the variance in the costs of processing a particular type or types of documents, and so forth. As another example, evaluating a measure of performance may comprise identifying an average amount of time spent processing a particular type or types of documents. Though, it should be recognized that these are only illustrative examples and that any numerous other patterns or trends may be identified by analyzing the gathered data.

Next, process 600 proceeds to decision block 606, where a determination is made of whether to update one or more rules in the set of rules used in act 602. This determination may be made in any suitable way. Making the determination may comprise evaluating a measure of performance for one or more documents processed by the document management system (e.g., during act 602 and/or at any other time). The determination of whether to update a rule used to process particular type of document may be made by evaluating the measure of performance with respect to one or more documents of that particular type. For instance, the determination of whether to update the rule(s) used to process invoices may be made by evaluating a measure of performance with respect to invoices processed by the system. As a specific example, a determination of whether to update the value of a parameter specifying a threshold amount in a rule that is used to decide whether to identify issues in invoices may be made based on the cost of processing invoices. In this scenario, invoices for an amount less than the threshold amount would not be processed to identify and/or resolve any particular issues. As such, the threshold amount may be set such that the amount of the invoice is higher than a cost associated with processing the invoice.

If it is determined, in decision block 606, that one or more rules are to be updated, process 600 proceeds, via the YES branch, to act 608 in which the rule(s) are updated. The rules may be updated in any suitable manner. As previously mentioned, a rule may be updated by changing the current value of a parameter associated with the rule to obtain a new value for the parameter. The new value may be determined in any suitable way and, for example, may be determined by using the measure of performance. For example, the measure performance may be evaluated with respect to a set of documents by using a set of other values for the parameter instead of the current value for the parameter. Then, the new value may be set to a value from the set of other values that led to the best measure of performance. As a specific example, the new value may be identified based on whether processing documents using a rule associated with a parameter having the new value leads to a reduction of costs and/or time in processing the documents (as may be indicated by a measure of performance). Though, it should be recognized that new parameter values may be set in any of numerous other ways based on any other suitable logic.

Next, process 600 proceeds to decision block 610, where it is determined whether at least another document should be processed. As such, it may be determined that a previously-processed document or documents and/or any other suitable document or documents should be processed. It should be noted that process 600 may proceed to decision block 610 in one of two ways: either after one or more rules are updated in act 608, or if it is determined, in decision block 606, that no rules are to be updated. The determination of whether at least another document should be processed may be made in any suitable way, as the nature of this determination is not a limitation of aspects of the present invention.

In some embodiments, decision blocks 606, 610 and act 608 may be performed by rule adaptation module 316 to update one or more rules. As such, these decision blocks and acts may be performed at any suitable time, as previously described with respect to rule adaptation module 316.

The above-described embodiments of the present invention can be implemented in any of numerous ways. For example, the embodiments may be implemented using hardware, software or a combination thereof. When implemented in software, the software code may be executed on any suitable processor or collection of processors, whether provided in a single computer or distributed among multiple computers.

It should be appreciated that a computer may be embodied in any of numerous forms, such as a rack-mounted computer, a desktop computer, a laptop computer, or a tablet computer. Additionally, a computer may be embodied in any device with suitable processing capabilities, including a Personal Digital Assistant (PDA), a smart phone, or any other suitable portable or fixed electronic device.

Also, a computer may have one or more input and output devices. These devices may be used, among other things, to present a user interface. Examples of output devices that may be used to provide a user interface include printers or display screens for visual presentation of output, and speakers or other sound generating devices for audible presentation of output. Examples of input devices that may be used for a user interface include keyboards, microphones, and pointing devices, such as mice, touch pads, and digitizing tablets.

Such computers may be interconnected by one or more networks in any suitable form, including a local area network (LAN) or a wide area network (WAN), such as an enterprise network, an intelligent network (IN) or the Internet. Such networks may be based on any suitable technology and may operate according to any suitable protocol and may include wireless networks, wired networks, and/or any suitable combination thereof.

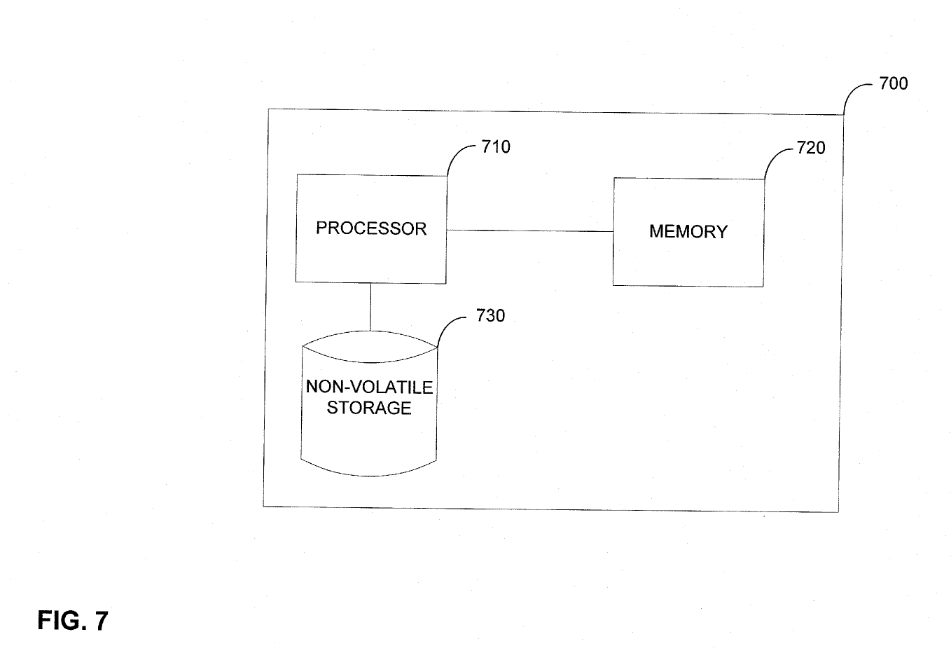

An illustrative implementation of a computer system 700 that may be used in connection with any of the embodiments of the invention described herein is shown in FIG. 7. The computer system 700 may include one or more processors 710 and one or more non-transitory computer-readable storage media (e.g., memory 720 and one or more non-volatile storage media 730). The processor 710 may control writing data to and reading data from the memory 720 and the non-volatile storage device 730 in any suitable manner, as the aspects of the invention described herein are not limited in this respect. To perform any of the functionality described herein, the processor 710 may execute one or more processor-executable instructions stored in one or more non-transitory computer-readable storage media (e.g., the memory 720), which may serve as non-transitory computer-readable storage media storing instructions for execution by the processor 710.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., one or more computer memories, one or more floppy discs, one or more compact discs, one or more optical discs, one or more magnetic tapes, one or more flash memories, one or more circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Processor-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more methods, of which illustrative examples have been described with respect to FIGS. 4 and 6. The acts performed as part of the method may be ordered in any suitable way. Accordingly, embodiments may be constructed in which acts are performed in an order different from the order illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A system for adaptively processing a plurality of documents associated with one or more transactions, the system comprising:
at least one processor configured to perform acts of:
processing at least a first document of the plurality of documents based at least in part on a first rule, wherein the first rule uses a first value for a first parameter associated with the first rule,
determining whether to update the first rule based at least in part on a measure of performance evaluated for the first document, and
if it is determined based on the measure of performance that the first rule is to be updated, updating the first rule by changing the first value of the first parameter to a second value different from the first value.

2. The system of claim 1, wherein the at least one processor is further configured to perform an act of processing at least a second document of the plurality of documents based at least in part on the updated first rule.

3. The system of claim 1, wherein processing at least the first document comprises processing a plurality of documents based at least in part on the first rule and wherein determining whether to update the first rule comprises evaluating the measure of performance for each document in the plurality of documents.

4. The system of claim 1, wherein the act of processing the first document comprises:
identifying at least a first unresolved issue associated with the first document;
presenting information associated with the first unresolved issue to a user;
receiving input from the first user in response to the presented information; and
resolving the first unresolved issue based at least in part on the input received from the first user.

5. The system of claim 1, wherein the measure of performance for the first document is indicative of a cost associated with processing the first document.

6. The system of claim 1, wherein processing the first document based at least in part on the first rule comprises using a rules engine to evaluate the first rule using data associated with the first document to determine how to process the first document.

7. The system of claim 6, wherein evaluating the first rule using the data associated with the first document produces an indication of whether to identify and/or resolve one or more issues associated with the first document.

8. The system of claim 7, wherein the first document is an invoice and the first rule comprises a parameter specifying a threshold amount, and wherein processing the first document comprises:
determining whether to identify and/or resolve the one or more issues with the first document based at least in part on whether an amount in the invoice exceeds the threshold amount; and
if it is determined that the amount in the invoice exceeds the threshold amount, performing at least one of identifying and resolving the one or more issues with the first document.

9. A method for adaptively processing a plurality of documents associated with one or more transactions, the method comprising:
using at least one processor to perform acts of:
processing at least a first document of the plurality of documents based at least in part on a first rule, wherein the first rule uses a first value for a first parameter associated with the first rule,
determining whether to update the first rule based at least in part on a measure of performance evaluated for the first document, and
if it is determined based on the measure of performance that the first rule is to be updated, updating the first rule by changing the first value of the first parameter to a second value different from the first value.

10. The method of claim 9, further comprising using the at least one processor to perform an act of processing at least a second document of the plurality of documents based at least in part on the updated first rule.

11. The method of claim 9, wherein the act of processing the first document comprises:
identifying at least a first unresolved issue associated with the first document;
presenting information associated with the first unresolved issue to a user;
receiving input from the first user in response to the presented information; and
resolving the first unresolved issue based at least in part on the input received from the first user.

12. The method of claim 9, wherein the measure of performance for the first document is indicative of a cost associated with processing the document.

13. The method of claim 9, wherein processing the first document based at least in part on the first rule comprises using a rules engine to evaluate the first rule using data associated with the first document to produce an indication of whether to identify and/or resolve one or more issues associated with the first document.

14. The method of claim 13, wherein the first document is an invoice and the first rule comprises a parameter specifying a threshold amount, and wherein processing the first document comprises:
determining whether to identify and/or resolve the one or more issues with the first document based at least in part on whether an amount in the invoice exceeds the threshold amount; and
if it is determined that the amount in the invoice exceeds the threshold amount, performing at least one of identifying and resolving the one or more issues with the first document.

15. At least one non-transitory computer-readable storage medium storing processor-executable instructions that, when executed by at least one processor, cause the at least one processor to perform a method for adaptively processing a plurality of documents associated with one or more transactions, the method comprising:
processing at least a first document of the plurality of documents based at least in part on a first rule, wherein the first rule uses a first value for a first parameter associated with the first rule,
determining whether to update the first rule based at least in part on a measure of performance evaluated for the first document, and
if it is determined based on the measure of performance that the first rule is to be updated,
updating the first rule by changing the first value of the first parameter to a second value different from the first value.

16. The at least one non-transitory computer-readable storage medium of claim 15, further comprising processing at least a second document of the plurality of documents based at least in part on the updated first rule.

17. The at least one non-transitory computer-readable storage medium of claim 15, wherein the act of processing the first document comprises:
identifying at least a first unresolved issue associated with the first document;
presenting information associated with the first unresolved issue to a user;
receiving input from the first user in response to the presented information; and
resolving the first unresolved issue based at least in part on the input received from the first user.

18. The at least one non-transitory computer-readable storage medium of claim 15, wherein the measure of performance for the first document is indicative of a cost associated with processing the document.

19. The at least one non-transitory computer-readable storage medium of claim 15, wherein processing the first document based at least in part on the first rule comprises using a rules engine to evaluate the first rule using data associated with the first document to produce an indication of whether to identify and/or resolve one or more issues associated with the first document.

20. The at least one non-transitory computer-readable storage medium of claim 19, wherein the first document is an invoice and the first rule comprises a parameter specifying a threshold amount, and wherein processing the first document comprises:
determining whether to identify and/or resolve the one or more issues with the first document based at least in part on whether an amount in the invoice exceeds the threshold amount; and
if it is determined that the amount in the invoice exceeds the threshold amount, performing at least one of identifying and resolving the one or more issues with the first document.
